(19) United States
(12) Patent Application Publication
(10) Pub. No.: US 2023/0238757 A1
(43) Pub. Date: Jul. 27, 2023

(54) SINGLE-PAIR ETHERNET MULTI-WAY COUPLERS

(71) Applicant: CommScope Technologies LLC, Hickory, NC (US)

(72) Inventors: Paul John PEPE, Clemmons, NC (US); Shawn Phillip TOBEY, Trinity, NC (US)

(21) Appl. No.: 18/001,383

(22) PCT Filed: Jun. 11, 2021
(86) PCT No.: PCT/US2021/037070

§ 371 Date: Dec. 9, 2022

Related U.S. Application Data
(60) Provisional application No. 63/154,382, filed on Feb. 26, 2021.
(60) Provisional application No. 63/038,538, filed on Jun. 12, 2020.

(51) Int. Cl. H01R 31/06; H01R 31/02; H01R 13/6585

(52) U.S. Cl. CPC H01R 31/06; H01R 31/02; H01R 13/6585; H01R 2201/04; H01R 13/6583

(57) ABSTRACT

A multi-way coupler includes a housing having at least three connector-receiving channels, a circuit board contained within the housing and at least three pairs of contacts including exactly one pair of contacts per each of the at least three connector-receiving channels. Each of the contacts includes a forward end extending into the respective connector-receiving channel and a rearward end electrically coupled to the circuit board. Further, each of the pair of contacts includes a first contact and a second contact with the circuit board including a first set of traces to electrically couple all of the first contacts together and a second set of traces to electrically couple all of the second contacts together. The multi-way coupler has a shielded configuration and a non-shielded configuration

### CROSS-REFERENCE TO RELATED APPLICATION

This application is being filed on Jun. 11, 2021 as a PCT International Patent Application and claims the benefit of U.S. Patent Application Ser. Nos. 63/038,538, filed on Jun. 12, 2020, entitled “SINGLE-PAIR ETHERNET MULTI-WAY COUPLERS”; and 63/154,382, filed on Feb. 26, 2021, entitled “COUPLERS FOR SINGLE PAIR COUNNECTORS”; the disclosures of which are incorporated herein by reference in their entireties.

### TECHNICAL FIELD

The present disclosure is directed to single-pair ethernet systems for transmitting data, power or both data and power over a single twist pair of wire conductors and, more specifically, to multi-way couplers for coupling a plurality of single-pair ethernet connectors.

### BACKGROUND

A single twisted pair of conductors can be used to transmit data and/or power over a communications network that includes, for example, computers, servers, cameras, televisions, and other electronic devices including those on the internet of things (IoT), etc. In the past, this has been performed through use of Ethernet cables and connectors that typically include four pairs of conductors that are used to transmit four differential signals. Differential signaling techniques, where each signal is transmitted over a balanced pair of conductors, are used because differential signals may be affected less by external noise sources and internal noises sources such as crosstalk as compared to signals that are transmitted over unbalanced conductors.

In Ethernet cables, the insulated conductors of each differential pair are tightly twisted about each other to form four twisted pairs of conductors, and these four twisted pairs may be further twisted about each other in a so-called “core twist.” A separator may be provided that is used to separate (and hence reduce coupling between) at least one of the twisted pairs from at least one other of the twisted pairs. The four twisted pairs and any separator may be enclosed in a protective jacket. Ethernet cables are connectorized with Ethernet connectors; a single Ethernet connector is configured to accommodate all four twisted pairs of conductors. However, it is possible that data and/or power transfer can be effectively supported through a singled twisted pair of conductors with its own more compact connector and cable. Couplers that can enable electrical coupling of connectors, with each connector coupled to a single pair of electrical conductors, are an important element in broadening the use of data and/or power transfer over a single pair of electrical conductors.

### SUMMARY

In certain aspects, the present disclosure is directed to a multi-way coupler. The multi-way coupler includes a housing having at least three connector-receiving channels, a circuit board contained within the housing and at least three pairs of contacts including exactly one pair of contacts per each of the at least three connector-receiving channels. Each of the contacts includes a forward end extending into the respective connector-receiving channel and a rearward end electrically coupled to the circuit board. Further, each of the pair of contacts includes a first contact and a second contact with the circuit board including a first set of traces to electrically couple all of the first contacts together and a second set of traces to electrically couple all of the second contacts together. The multi-way coupler has a shielded configuration and a non-shielded configuration. The multi-way coupler serves to electrically coupler connectors having exactly two contacts that are coupled to a single twisted pair of conductive wires that deliver power, data or both power and data.

In certain aspects, the present disclosure is directed to a method for establishing a power and/or data system bus architecture. The method includes: (a) supplying power and/or data via a first connector coupled to a first connector-receiving channel of a first coupler having at least three connector-receiving channels; (b) providing the supplied power and/or data via a second connector received in a second connector-receiving channel of the at least three connector-receiving channels of the first coupler to a first power device; and (c) providing the supplied power and/or data via a third connector received in a third connector-receiving channel of the at least three connector-receiving channels of the first coupler to a second coupler having at least three connector-receiving channels.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE FIGURES

FIGS. 1A-1B illustrate example embodiments of cables having single twisted pairs of conductors.

FIGS. 2A-2D illustrate an example embodiment of a free connector for a single pair of electrical conductors including an assembled view, an exploded assembly view, a cross section of a forward connector body of the connector and a pair of electrical contacts of the connector, respectively.

FIGS. 3A-3C illustrate an example embodiment of a fixed connector, which is configured to mate with the free connector of FIGS. 2A-2D, including an assembled perspective view, a front view and a pair of electrical contacts of the fixed connector, respectively.

FIGS. 4A-4D illustrate an example embodiment of a shielded coupler including an assembled perspective, an exploded assembly perspective, a side cross-sectional, and a top cross-sectional view of the coupler, respectively.

FIGS. 5A-5B provide perspective views of a pair of the connectors of FIGS. 2A-2D before and after electrical coupling with the coupler of FIGS. 4A-4D.

FIG. 6 is a perspective view of a 3-way coupler coupling three free connectors of FIGS. 2A-2C.

FIGS. 7A-7B provide first and second perspective view of the 3-way coupler of FIG. 6.

FIG. 8 is an exploded view of the 3-way coupler of FIG. 6.

FIGS. 9A-9B are cross-sectional views of the 3-way coupler of FIG. 6.

FIG. 10 is a cross-sectional view of the 3-way coupler of FIG. 6 with connectors.

FIG. 11 illustrates an example architecture utilizing the 3-way coupler of FIG. 6.

FIG. 12 is a perspective view of a 4-way coupler coupling four free connectors.

FIGS. 13A-13B provides first and second perspective view of the 4-coupler of FIG. 12.

FIG. 14 is an exploded view of the 4-way coupler of FIG. 12.

FIGS. 15A-15B are cross-sectional views of the 4-way coupler of FIG. 12.

FIG. 16 is a cross-section view of the 4-way coupler of FIG. 12 with connectors.

FIG. 17 is an example architecture utilizing the 3-way coupler of FIG. 12.

FIGS. 18A-18B are perspective and top views, respectively, a multi-way coupler using the fixed connector of FIGS. 3A-3C.

FIG. 19 is an exploded view of the multi-way coupler of FIGS. 18A-18B using the fixed connector of FIGS. 3A-3C.

FIGS. 20A-20E illustrate example embodiments of a 3-way coupler.

FIG. 21 is a cross-sectional view a coupler with a contact sub-assembly including a circuit board.

FIG. 22 is a perspective exploded view of the contact sub-assembly of FIG. 21.

### DETAILED DESCRIPTION

The present disclosure is directed to multi-way couplers including a 3-way coupler, a 4-way coupler and a coupler that can be configured for 2-way, 3-way or 4-way coupling. The couplers couple single pair ethernet connectors with each connector coupled to a single twisted pair of electrical conductors for transmitting data, power or both data and power. The couplers utilize first circuit board traces to electrically couple first contacts of all connectors and second circuit board traces to electrically couple second contacts of all connectors. The multi-way couplers enable daisy-chaining of single-pair ethernet patch cords to power and/or transmit data to a plurality of power devices (e.g., lighting, cameras, etc.) that are configured to interface with single pair ethernet.

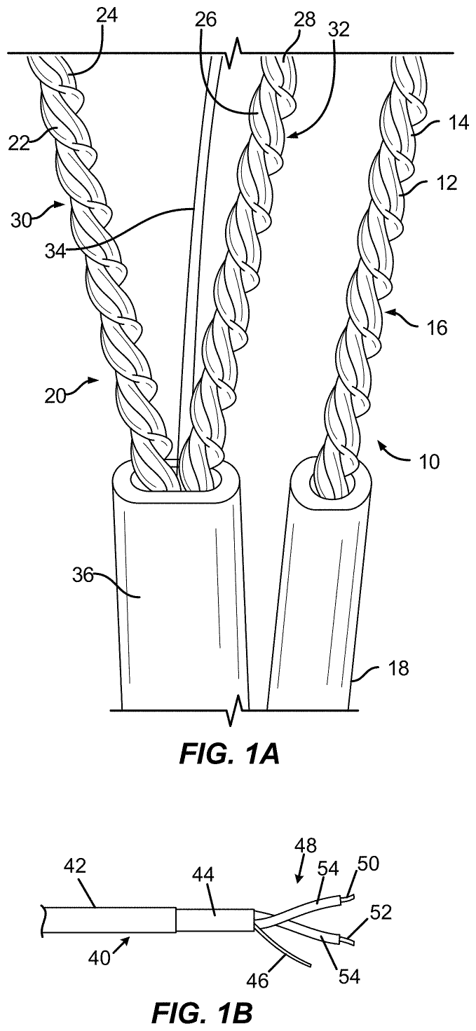

FIG. 1A illustrates two example embodiments of cables containing one or more single twisted pairs of conductors, such as copper wires, capable of transmitting electricity and/or data. The first cable 10 includes first and second conductors 12, 14 that are twisted together to form a single twisted pair 16. The conductors 12, 14 are enclosed by a protective jacket 18. The second cable 20 includes first through fourth conductors 22, 24, 26, 28. Conductors 22 and 24 are twisted together to form a first single twisted pair 30, and conductors 26 and 28 are twisted together to form a second single twisted pair 32. The twisted pairs 30 and 32 are separated by a separator 34 and are encased in a protective jacket 36. In certain example embodiments, the cables 10, 20 include a number of twisted pairs greater than two. In certain example embodiments, each single twisted pair of conductors, e.g., 16, 30, 32, is configured for data transmission up to 600 MHz (ffs) and has a current carrying capacity up to 1 A. Each single twisted pair of conductors, e.g., 16, 30, 32, can be connectorized with the various embodiments or combination of embodiments of free connectors and fixed connectors as described herein. FIG. 1B is an example of a shielded cable 40. The shielded cable 40 includes an outer jacket 42, a foil shield 44, a drain wire 46, and a single twisted pair 48 of conductors 50 and 52; each of the conductors 50 and 52 is provided with insulation 54.

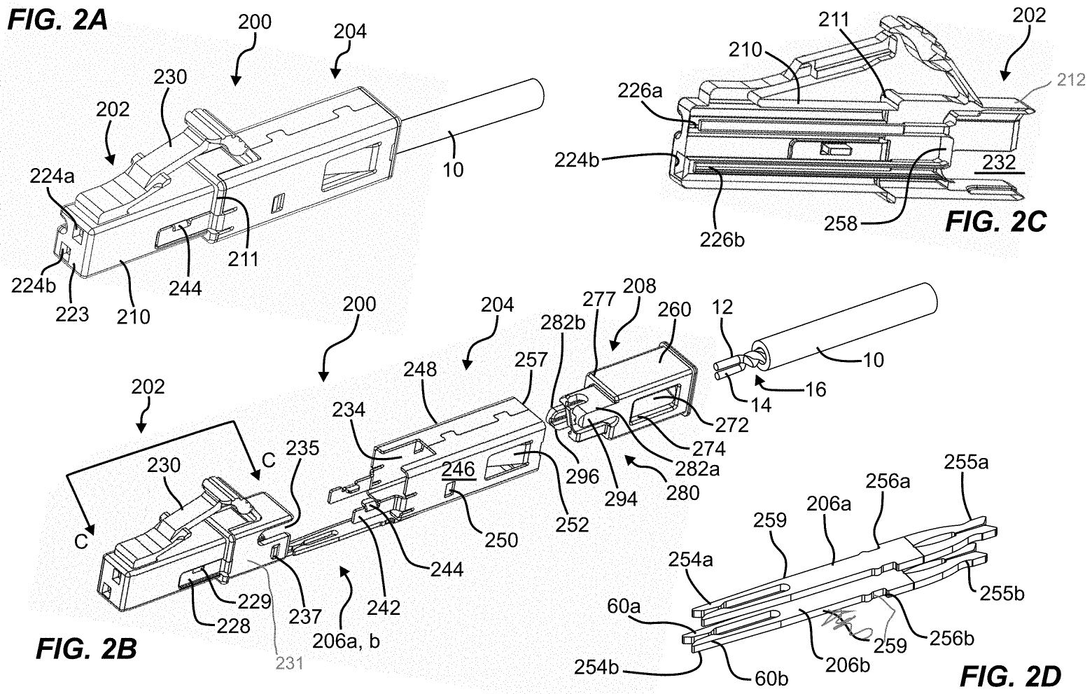

Referring to FIGS. 2A-2C an example embodiment of a free connector 200 for a single twisted pair of electrical conductors is illustrated. Free connector 200 includes a forward connector body 202, a metal frame 204, a pair of electrical contacts 206a, 206b and a rear connector body 208. Free connector 200 can be coupled to a single twisted pair of conductors, e.g., conductors 12 and 14 of the single twisted pair 16 of cable 10.

The forward connector body 202 includes an elongate forward portion 210 and a rear receiving portion 212 that is separated by a shoulder 211.

The elongate forward portion 210 of the forward connector body 202 includes a forward face 223 having a pair of offset openings 224a, 224b corresponding to contact receiving channels 226a, 226b; the openings 224a, 224b receive pin contacts that electrically interface with the tuning fork contacts 206a, 206b. In certain embodiments, a recess 228 is provided on each side face of the elongate forward portion 210 to interface with and retain the metal frame 204. Each recess 228 includes a recessed notch 229 to receive an interfacing tab 244 of the metal frame 204 to further ensure that the metal frame 204 remains secured to the forward connector body 202. The forward connector body 202 also includes a cantilevered latch 230.

The rear receiving portion 212 of the forward connector body 202 is unitary (e.g. molded as a single unit) with the elongate forward portion 210 of the forward connector body 202. The rear receiving portion 212 defines a central cavity 232 that provides rear access to the contact receiving channels 226a, 226b of the elongate forward portion 210. Each side face 231, 233 of the rear receiving portion 212 includes a slot 235 to interface with the rear connector body 208 and an outward extending tab 237 to interface with the metal frame 204.

The metal frame 204 of the free connector 200 comprises a metal shell body 240 having a central cavity 234 that is slideable over the rear receiving portion 212 of the forward connector body 202. The metal frame 204 is held in place about the rear receiving portion 212 through use of a pair of flex tabs 242 that interface with corresponding recesses 228 of the forward connector body 202. Each of the flex tabs 242 includes in inward facing tab 244 to interface with recessed notch 229 of the forward connector body 202. Each side face 246, 248 of the metal frame 204 includes an opening 250 to interface with outward extending tab 237 of the forward connector body 202. Each point of interface between the metal frame 204 and the forward connector body 202 assists in securing the metal frame 204 to the forward connector body 202. Each side face 246, 248 of the metal frame 204 is additionally equipped with an inward directed beam 252 (e.g. shield beam) to establish an electrical interface with a cable shield (foil or drain wire) of the cable carrying the single pair of conductors (e.g., see FIG. 1B). Note that, while the metal frame 204 includes a shield beam for interfacing with a shield of a shielded cable, the metal frame 204 can also be utilized in conjunction with a non-shielded cable. In the instance of a non-shielded cable, the metal frame provides additional structural support to the connector 200. In certain non-shielded uses, the frame 204 is alternatively made of a non-metal material, e.g., plastic.

Electrical contacts 206a, 206b each include a forward portion having a tuning fork receptacle contact 254a, 254b while a rear portion of each of the electrical contacts 206a, 206b includes an insulation displacement contact (IDC) 255a, 255b. Each tuning fork receptacle contact 254a, 254b includes a pair of opposing spring arms 60a, 60b presenting an angled opening to receive a pin contact. Each of the electrical contacts 206a, 206b includes a shoulder 256a, 256b that interfaces with a stop 258 (see FIG. 2C) within the elongate forward portion 210 of the forward connector body 202. The electrical contacts 206a, 206b include one or more tangs 259 to help retain each of the tuning fork receptacle contacts 254a, 254b within their respective contact receiving channels 226a, 226b of the forward connector body 202.

The rear connector body 208 of the free connector 200 includes a rear body portion 260 that defines a central cavity 272 into which is inserted a pair of conductors (e.g., conductors 12, 14). Each side face is provided with an elongate opening 274 into which the inward directed beams 252 of the metal frame 204 extend wherein an electrical interface with the foil (or drain wire) of a conductor within the cavity 272 is established. A latch (now shown) on a lower face of the rear body portion 260 interfaces with a cut-out (not shown) of the metal frame 204 to secure the rear connector body 208 to the metal frame 204. A lip edge 277 of the rear body portion 260 seats against a rear face 257 of the metal frame 204.

The rear connector body 208 of the free connector 200 includes a contact receiving portion 280 that extends forward from the rear body portion 260. The contact receiving portion 280 is essentially divided into a first half 282a to accommodate the upper positioned electrical contact 206a and a second half 282b to accommodate the lower positioned electrical contact 206b. The first half 282a of the contact receiving portion 280 includes an upward channel that is contoured to direct the end of a conductor upward (e.g., a 90 deg. bend) to extend through a contact receiving slot. The second half 282b of the contact receiving portion 280 includes a downward channel that is contoured to direct the end of a conductor downward (e.g., a 90 deg. bend) to extend through a contact receiving slot.

The IDC contacts 255a, 255a of the electrical contact 206a,206b are inserted into their respective contact receiving slots to establish an electrical interface with the conductor extending there through. The IDC contacts 255a, 255b applies a normal force to the respective conductor and cuts through both the insulation of the conductor and a portion of the conductor itself to create the electrical interface. Note that the electrical interface is established without requiring crimping of the conductor to the electrical contact, i.e. the electrical interface is crimp-less. The upward channel is, in part, defined by an upper outward extending arm 294 while the downward channel is, in part, defined by a lower outward extending arm 296. Each of upper outward extending arm 294 and lower outward extending arm 296 interface with respective corresponding slots 235 of the forward connector body 202 when the free connector 200 is assembled to assist in aligning and stabilizing the rear connector body 208 relative to the forward connector body 202.

Further details regarding the free connector 200 and/or a fixed connector 300 (described herein for reference) can be found in PCT Publication WO 2019/165466, entitled “Connectors and Contacts for a Single Twisted Pair of Conductors,” and filed Feb. 26, 2019. The noted PCT Publication is hereby incorporated by reference in its entirety.

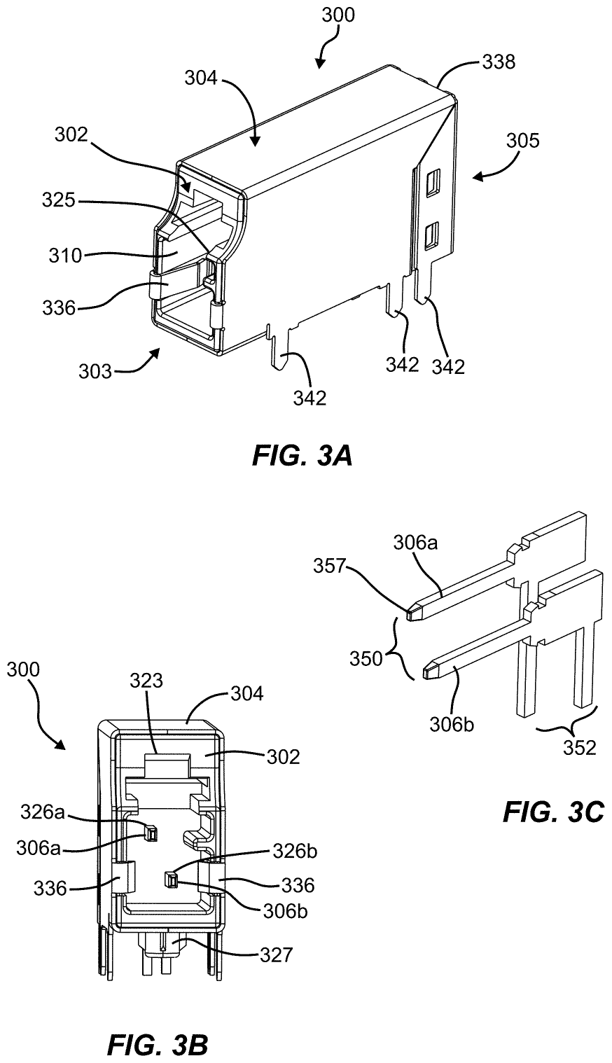

An example of a fixed connector 300, suitable to mate with free connector 200 is illustrated in FIGS. 3A-3C. The fixed connector 300 generally includes a housing body 302, a metal frame 304 and a pair of pin contacts 306a, 306b (straight or bent for board mounting). A forward end 303 and a rearward end 305 further define the fixed connector 300.

The housing body 302 of the fixed connector 300 includes a forward central channel 310 that receives the free connector 200. A notch 323 is provided within the housing body 302 to interface with the cantilevered latch 230 of the free connector 200. Further, side recesses 325 in each side face serve as an interface element for the metal frame 304. A mounting pin 327 extends from the housing body 302 and through the metal frame 2602 for circuit board mounting of the connector 300. The housing body further includes openings 326a, 326b to channels (not shown) into which the pin contacts 306a, 306b are inserted; when fully inserted, the pin contacts 306a, 306b extend into the forward central channel 310.

The metal frame 304 of the fixed connector 300 is a metal shell defining a central cavity that is slideable over the housing body 302. The metal frame 304 is held in place about the housing body 302 through use of a pair of clips 336 that interface with the side recesses 325. In certain embodiments, a back face 338 of the metal frame is enclosed with a back panel 340 while in other embodiments t back face 338 is left open. Further, in certain embodiments, the metal frame 304 is provide with one or more shield pins 342 that are insertable into vias in an application where the fixed connector 300 is board mounted.

Each of the pin contacts 306a, 306b of the fixed connector 300 include a forward portion 350 and a rear portion 352 that can be electrically coupled to a conductor, e.g. conductor 10, in any suitable manner. The forward portion 350 includes tapered faces that form a four-sided pyramid shape with a flattened apex 357; the flattened apex 357 having a rectangular or square cross-section.

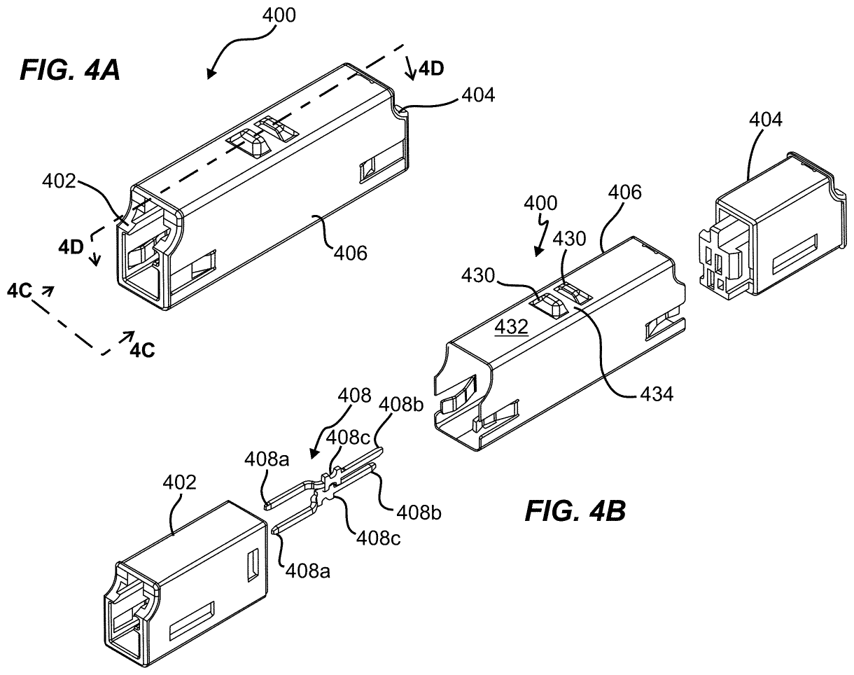

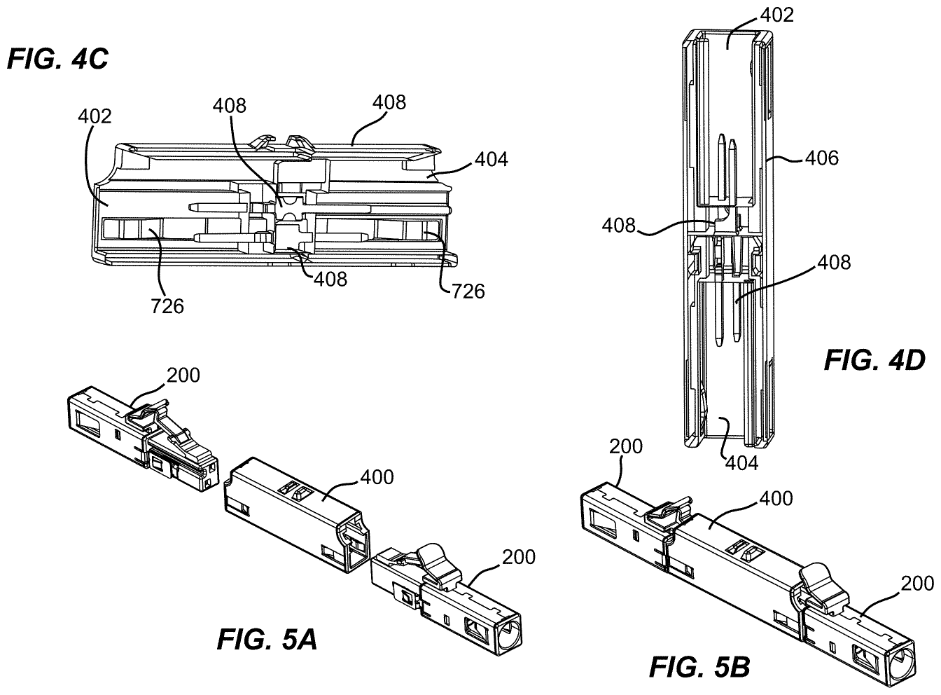

Referring to FIGS. 4A-4B an example embodiment of a coupler 400 is illustrated. As shown, the coupler 400 includes a first housing 402, a second housing 404, a metal shield 406 and a pair of contacts 408, each having a forward contact 408a and a rearward contact 408b separated by a central portion 408c. The first housing and second housing 402, 404 securely interface with one other to centrally support the first pair of contacts 408 enabling the first ends 408a of the contacts 408 to extend towards a first end 412 of the coupler 400 and the second ends 408b of the coupler 400 to extend towards a second end 414 of the coupler. FIGS. 4C and 4D provide cross-sectional views of the assembled coupler, including the metal shield 406, taken along lines 4C-4C and 4D-4D, respectively, of FIG. 4A, with each illustrating the placement of the first housing 402, the second housing 404, the metal shield 406 and the pair of contacts 408. FIGS. 5A and 5B illustrate the assembled coupler 400 with two of the free connectors 200 ready to be received by the coupler 400 and with the two connectors 200 removably received within the coupler 400 and electrically coupled, respectively. Each of the couplers 400 includes a pair of opposing projections 430 projecting away from a top face 432 of the coupler 400; the projections 430 define a channel 434. The projections 430 and channel 434 are used to position the coupler 400 in a high density panel (not shown).

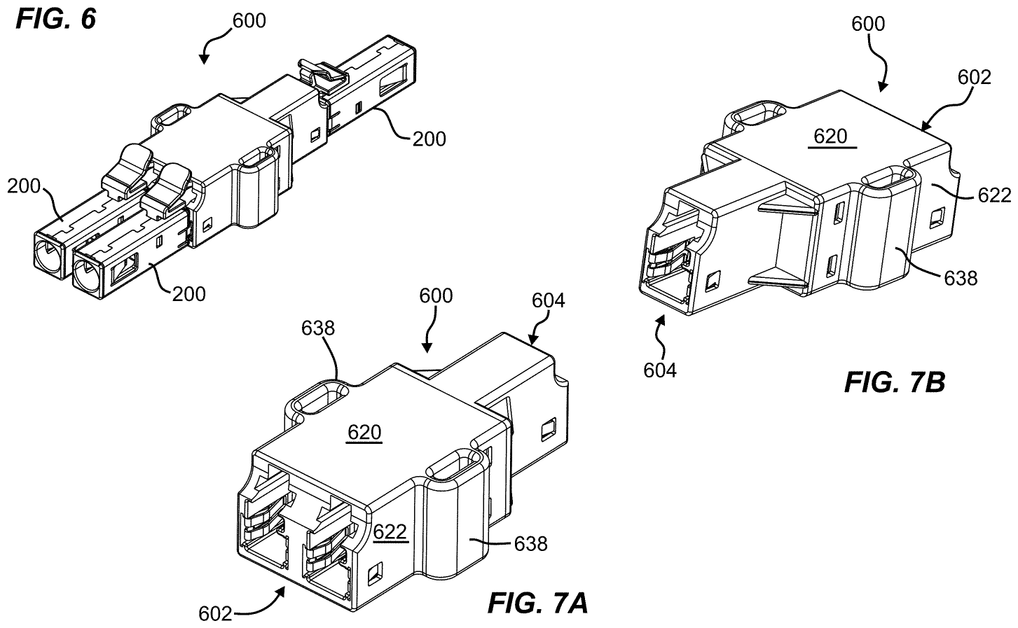

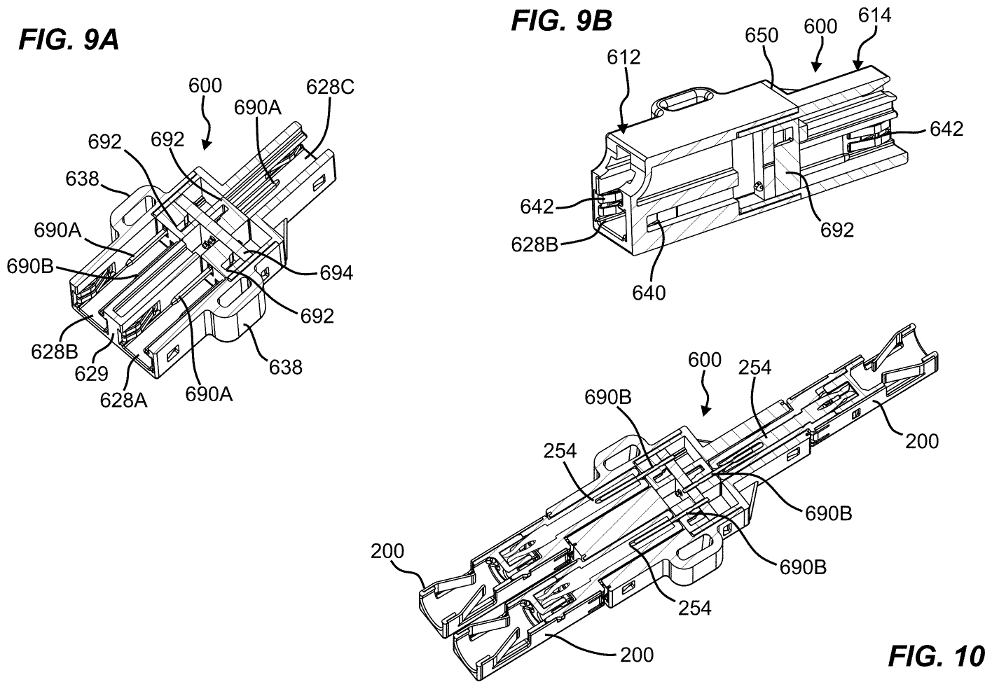

Referring to FIGS. 6-10 an example embodiment of a 3-way coupler 600 according to the present disclosure is illustrated. As shown, the 3-way coupler 600 is configured to couple three of the free connectors 200 with a dual-connector end 602 and single-connector end 604. Each of the free connectors 200 is coupled to a single twisted pair of electrical conductors that transmit power, data, or both power and data. In certain example embodiments, the free connector 200 is at the end of a patch cord (e.g., a length of cable containing the single twisted pair with a connector 200 or 300 at each end) while in other example embodiments the free connector is coupled to a single twisted pair cable to that is coupled a power and/or data source.

The 3-way coupler 600 includes a housing 610 comprising a first body portion 612 presenting the dual-connector end 602 and a second body portion 614 presenting the single-connector end 604. For applications requiring shielding, the housing 610 is preferably of a conductive metal and can be manufactured, for example, through die casting. In non-shielding applications, the housing is of preferably of non-conductive material such as plastic. The 3-way coupler 600 additionally includes a contact sub-assembly 616 contained within the housing 610.

The first body portion 612 includes an upper wall 620 and a lower wall 622 connected by side walls 624 and 626 to present a first face 627 that includes first and second connector-receiving channels 628A, 628B, which are divided by a central wall 629, and a second face 630 that includes an opening 632 to receive the second body portion 614. Each of the side walls 622, 624 includes an opening 634, a pair of slots 636 and a wire tie retainer 638. The central wall 629 includes an opening 640 to either side and proximate the first face that is positioned opposite the opening 634. Two retention clips 642, each of which includes an interface tab 644 and a pair of flex arms 646, are provided for each of the connector-receiving channels 628A, 628B. The interface tab 644 of each of the retention clips 642 interfaces with one of the openings 634 or 640 to maintain its position within the respective connector-receiving channel 628A, 628B. In shielding applications, the interface tab 644 is preferably of a conductive metal to establish a conductive interface between the first body portion 612 and the connector 200 received within the respective connector-receiving channel 628A, 628B. The wire tie retainer 638 provides an opening through which a cable tie, or other suitable tie, can be inserted for securing the coupler 600 in a certain location. In the instance of an application requiring shielding, a wire coupled to ground can be wound about (or screwed to) the wire retainer opening 638 thereby tying the connector 200 and the coupler 600 to ground.

The second body portion 614 includes a lip edge 650 defining a forward portion 652 presenting a connector-receiving channel 628C and a rearward portion 654 presenting a sub-assembly housing 656 for housing the contact sub-assembly 616. The forward portion 652 includes an upper wall 670 and a lower wall 672 connected by side walls 674 and 676 that form the connector-receiving channel 628C. Each of the side walls 674, 676 includes an opening 678 to interface with the interface tab 644 of an additional respective retention clip 642. The sub-assembly housing 656 of the rearward portion 654, which is received within the opening 632 of the first body portion 612, includes an upper wall 680 and lower wall 682 connected by side walls 684 and 686. Each of the side walls 684, 686 includes a pair of ramped tabs 688 that interface with the corresponding openings 636 of the first body portion 612 to retain the second body portion 614 in a closed position relative to the first body portion 612.

The sub-assembly 616 includes three pairs of contacts 690 with each pair of contacts including a first contact 690A and a second contact 690B as well as three identical contact support blocks 692 and a circuit board 694. Each of the contacts 690 includes a first end 696 comprising a pin contact that is received within a tuning fork receptacle contact 254a, 254b of the connector 200 and a second end 698 inserted into a corresponding via 699 on the circuit board 694. Each pair of contacts 690 is supported by a respective slot 700 of the contact support block 692 through which the contact 690 extends. The contact support blocks 692 are preferably of a lightweight non-conductive material such as plastic. A first set of traces on the circuit board 694 electrically connect all first contacts 690A to one another while a second set of traces on the circuit board 694 electrically connect all second contacts 690B to one another.

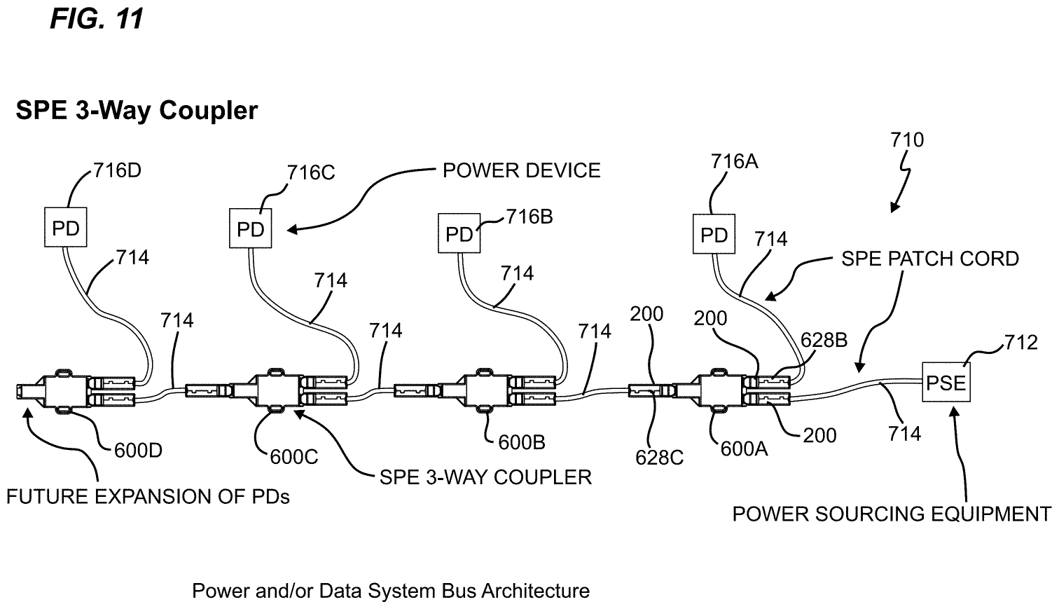

Referring to FIG. 11, a power and/or data system bus architecture 710 utilizing 3-way couplers 600 is illustrated. As shown, power sourcing equipment 712 supplies power and/or data, via a patch cord 714 having one or both ends terminated with the connector 200, to connector-receiving channel 628A of a first 3-way coupler 600A. The power/data supplied by the power sourcing equipment 712 is transmitted, via the circuit board 694, to connectors 200 and their respective patch cords 714, in connector-receiving channels 628B and 628C. The patch cord 714 associated with the connector-receiving channel 628B delivers power and/or data to a first power device 716A while the patch cord 714 associated connector-receiving channel 628 operating to couple the first 3-way coupler 600A with a second 3-way coupler 600B and deliver power and/or data thereto. The pattern can continue in a daisy-chain fashion with the coupling of a plurality of additional 3-way couplers 600 as illustrated.

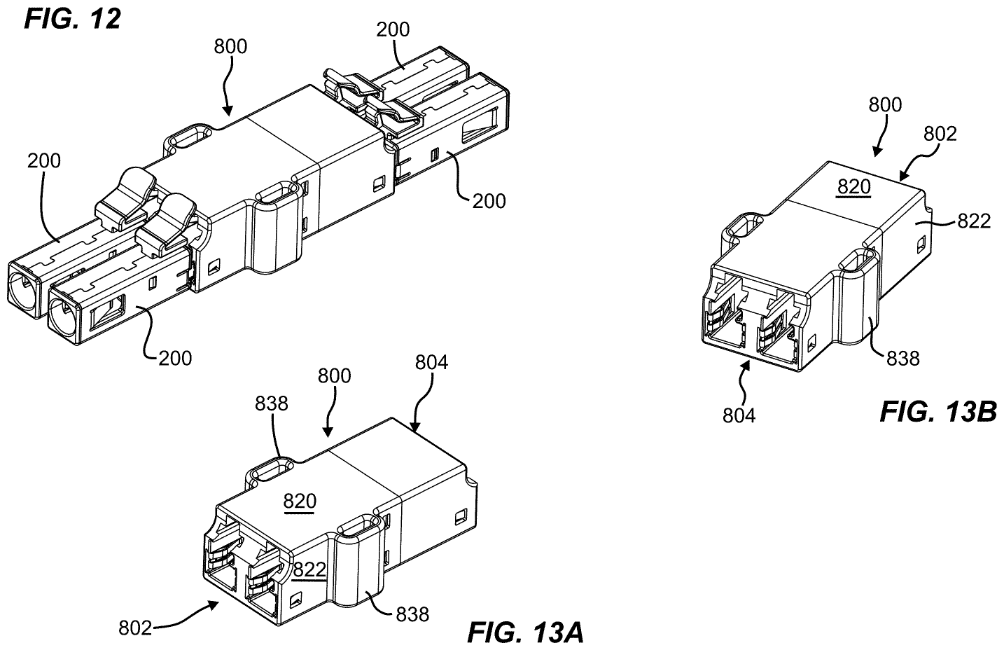

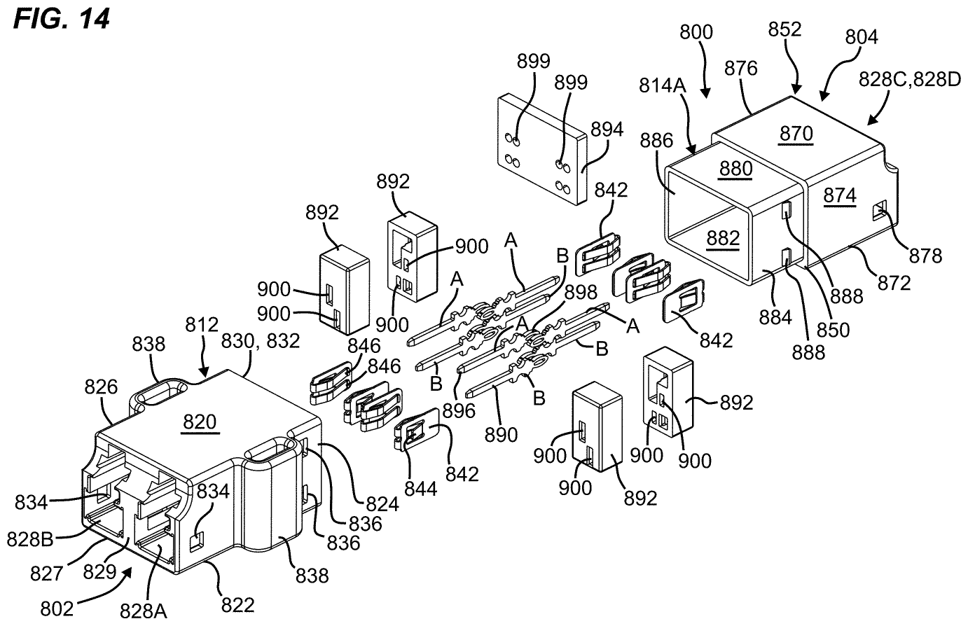

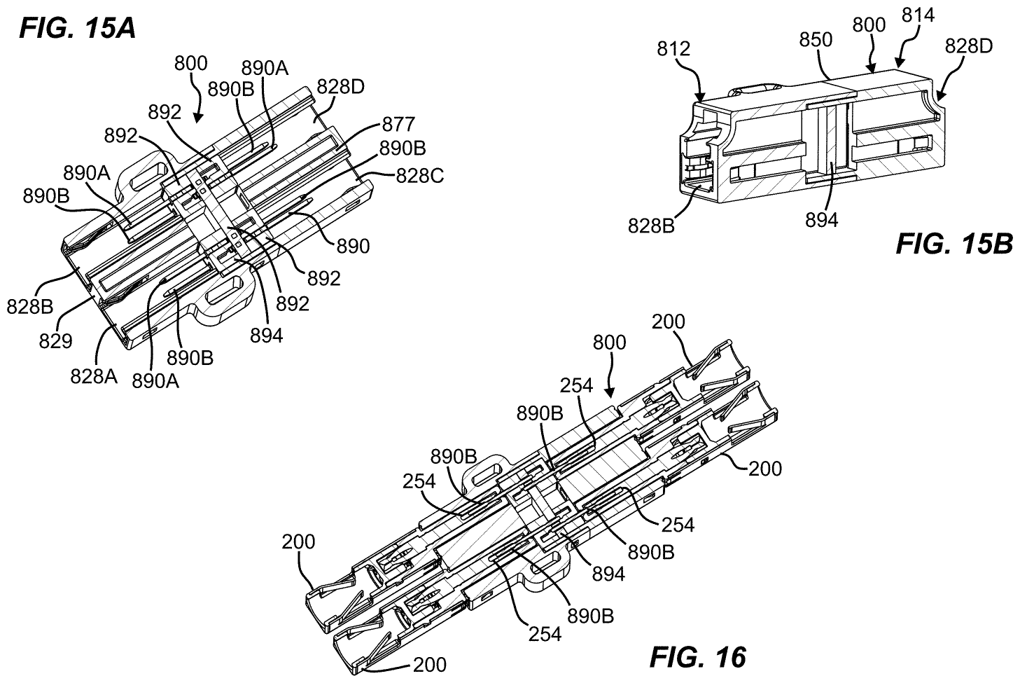

Referring to FIGS. 12-16 an example embodiment of a 4-way coupler 800 according to the present disclosure is illustrated. As shown, the 4-way coupler 800 is configured to couple four of the free connectors 200 with the dual-connector end 602 of the 3-way coupler 600 and a second dual-connector end 804. Each of the free connectors 200 is coupled to a single twisted pair of electrical conductors that transmit power, data, or both power and data. In certain example embodiments, the free connector 200 is at the end of a patch cord (e.g., a length of cable containing the single twisted pair with a connector 200 or 300 at each end) while in other example embodiments the free connector 200 is coupled to a single twisted pair cable to that is coupled a power and/or data source.

The 4-way coupler 800 includes a housing 810 comprising a first body portion 812, which is identical to and interchangeable with the first body portion 612 of the 3-way coupler 600, that presents a dual-connector end 602 and a second body portion 814 presenting the second dual-connector end 804. For applications requiring shielding, the housing 810 is preferably of a conductive metal and can be manufactured, for example, through die casting. In non-shielding applications, the housing is of preferably of a non-conductive material such as plastic. The 4-way coupler 800 additionally includes a contact sub-assembly 816 contained within the housing 810.

The first body portion 812 of the 4-way coupler includes an upper wall 820 and a lower wall 822 connected by side walls 824 and 826 to present a first face 827 that includes first and second connector-receiving channels 828A, 828B, which are divided by a central wall 829, and a second face 830 that includes an opening 832 to receive the second body portion 814. Each of the side walls 822, 824 includes an opening 834, a pair of slots 836 and a wire tie retainer 838. The central wall 829 includes an opening 840 to either side and proximate the first face that is positioned opposite the opening 834. Two retention clips 842, each of which includes an interface tab 844 and a pair of flex arms 846, are provided for each of the connector-receiving channels 828A, 828B. The interface tab 844 of each of the retention clips 842 interfaces with one of the openings 834 or 840 to maintain its position within the respective connector-receiving channel 828A, 828B. In shielding applications, the interface tab 844 is preferably of a conductive metal to establish a conductive interface between the first body portion 812 and the connector 200 received within the respective connector-receiving channel 828A, 828B. The wire tie retainer 838 provides an opening through which a cable tie, or other suitable tie, can be inserted for securing the coupler 800 in a certain location. In the instance of an application requiring shielding, a wire coupled to ground can be wound about (or screwed to) the wire retainer opening 838 thereby tying the connector 200 and the coupler 800 to ground.

The second body portion 814 includes a lip edge 850 defining a forward portion 852 presenting first and second connector-receiving channels 828C, 828C and a rearward portion 854 presenting a sub-assembly housing 856 for housing the contact sub-assembly 816. The forward portion 852 includes an upper wall 870 and a lower wall 872 connected by side walls 874 and 876 that, along with a central wall 877, form the connector-receiving channels 828C and 828D. Each of the side walls 874, 876, as well as each side of the central wall 877, includes an opening 878 to interface with the interface tab 844 of additional respective retention clips 842. The sub-assembly housing 856 of the rearward portion 854, which is received within the opening 832 of the first body portion 812, includes an upper wall 880 and lower wall 882 connected by side walls 884 and 886. Each of the side walls 884, 886 includes a pair of ramped tabs 888 that interface with the corresponding openings 836 of the first body portion 812 to retain the second body portion 814 in a closed position relative to the first body portion 812.

The sub-assembly 816 includes four pairs of contacts 890 with each pair of contacts including a first contact 890A and a second contact 890B as well as four identical contact support blocks 892 and a circuit board 894. Each of the contacts 890 includes a first end 896 comprising a pin contact that is received within a tuning fork receptacle contact 254a, 254b of the connector 200 and a second end 898 inserted into a corresponding via 899 on the circuit board 894. Each pair of contacts 890 is supported by a respective slot 900 of the corresponding contact support block 892 through which the contact 890 extends. The contact support blocks 892 are preferably of a lightweight non-conductive material such as plastic. A first set of traces on the circuit board 894 electrically connects all first contacts 890A to one another while a second set of traces on the circuit board 894 electrically connects all second contacts 890B to one another.

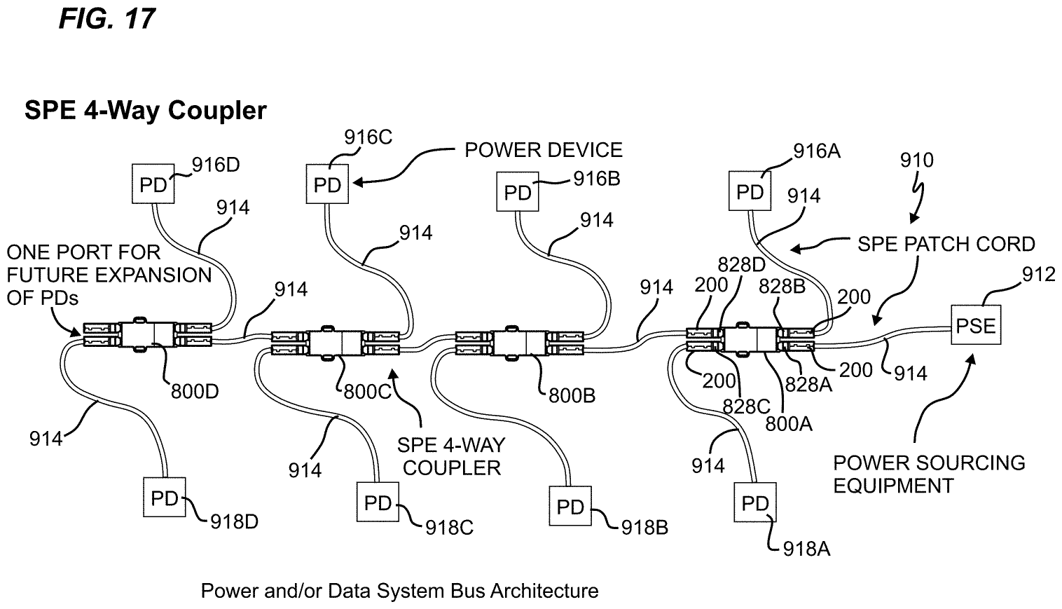

Referring to FIG. 17, a power and/or data system bus architecture 910 utilizing 4-way couplers 800 is illustrated. As shown, power sourcing equipment 912 supplies power and/or data, via a patch cord 914 having one or both ends terminated with the connector 200, to connector-receiving channel 828A of a first 4-way coupler 800A. The power/data supplied by the power sourcing equipment 912 is transmitted, via the circuit board 894, to connectors 200 and their respective patch cords 914, in connector-receiving channels 828B, 828C and 828D. The patch cord 914 associated with the connector-receiving channel 828B delivers power and/or data to a first power device 916A, while the patch cord 914 associated with the connector-receiving channel 828C delivers power and/or data to a second power device 918A and the patch cord 914 associated connector-receiving channel 828 operates to couple the first 4-way coupler 800A with a second 4-way coupler 800B and deliver power and/or data thereto. The pattern can continue in a daisy-chain fashion with the coupling of a plurality of additional 4-way couplers 800 as illustrated.

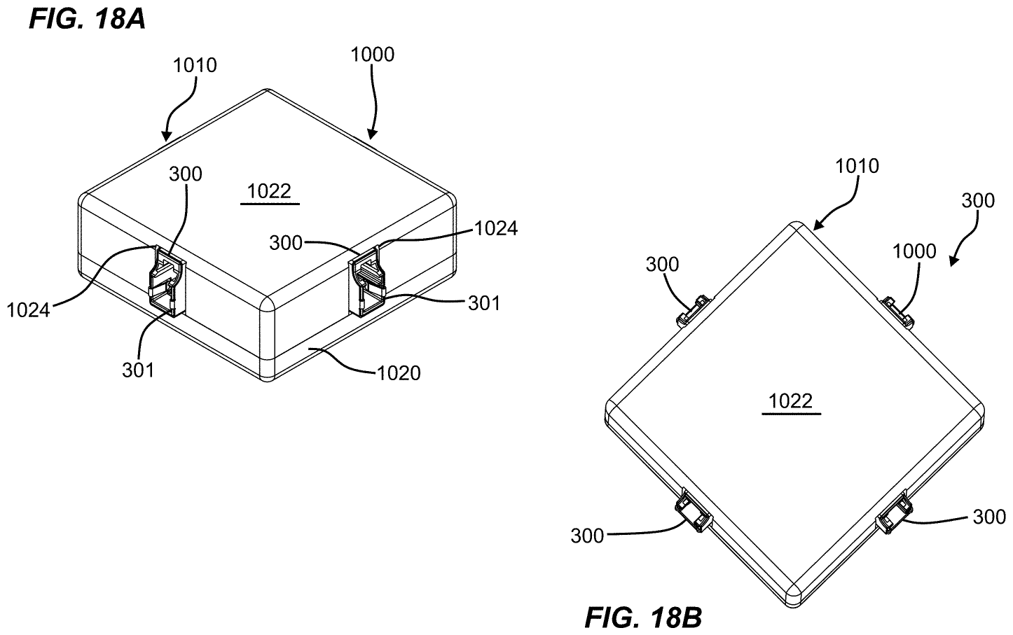

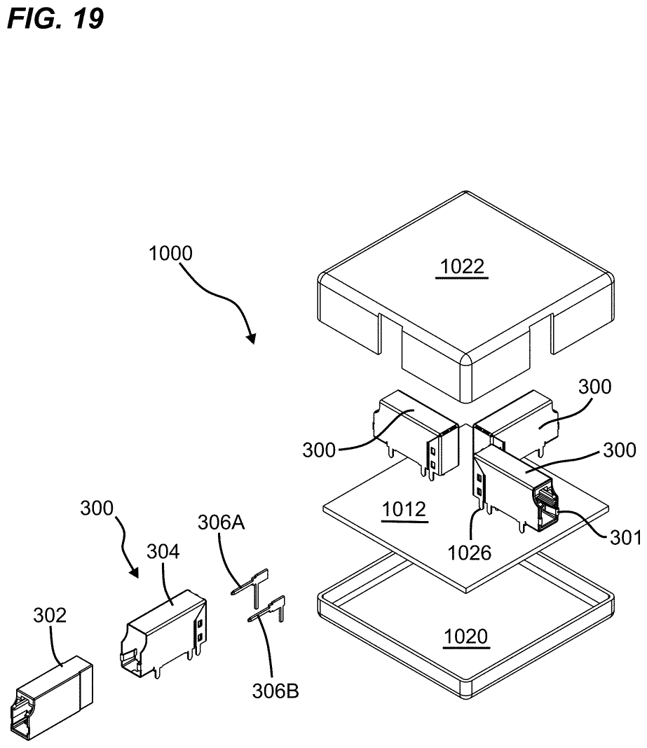

FIGS. 18A, 18B and 19 illustrate a multi-way coupler 1000 that can be configured to electrically couple 2, 3 4 or more connectors 300. The multi-way coupler 1000 has a housing 1010 that can be fabricated with conductive metal for shielding applications or non-conductive materials for non-shielding applications. The multi-way coupler generally includes the housing 1010, a circuit board 1012 and two, three or four connectors 300.

The housing 1010 of the multi-way coupler 1000 includes a base 1020 and a lid 1022, which can interface via a friction fit or other suitable manner of securing the base 1020 to the lid 1022. The lid 1022 includes a plurality of ports 1024 which can be closed off or left open to accommodate a forward face 301 of the connector 300; ports 1024 can be arranged one on each side as illustrated or with multiple ports 1024 on one or more sides. In the embodiment shown, the lid 1022 includes four ports 1024 each of which is open to accommodate the connector 300. The housing 1010 is sized to accommodate the circuit board 1012; the housing 1010 and circuit board 1012 may or may not be of a similar shape. Each of the connectors 300 includes two pin contacts including 306a, 306b each having one end that electrically interfaces (e.g., vias 1026 or soldering) with the circuit board 1012. A first set of traces electrically connect all of the 306a contacts while a second set of traces electrically connect all of the 306b contacts of the connectors 300. In shielding applications, the connectors 300 include the metal frames 304, which are electrically coupled to the circuit board 1012 and are in direct contact with the metal housing 1010 of the multi-way coupler 1000. In non-shielding applications, the connectors 300 need not include their respective metal frames 304. As with the 3-way couplers 600 and the 4-way couplers 800, the multi-way coupler 1000 can utilized in a daisy chain style configuration with one port of the multi-way coupler 1000 dedicated receiving power and/or data from a supply source and one port of the multi-way coupler 1000 dedicated to supply power and/or data to another multi-way coupler 1000; remaining ports on the on the multi-way coupler 1000 can be connected via patch cords to power devices thereby suppling power and/or data.

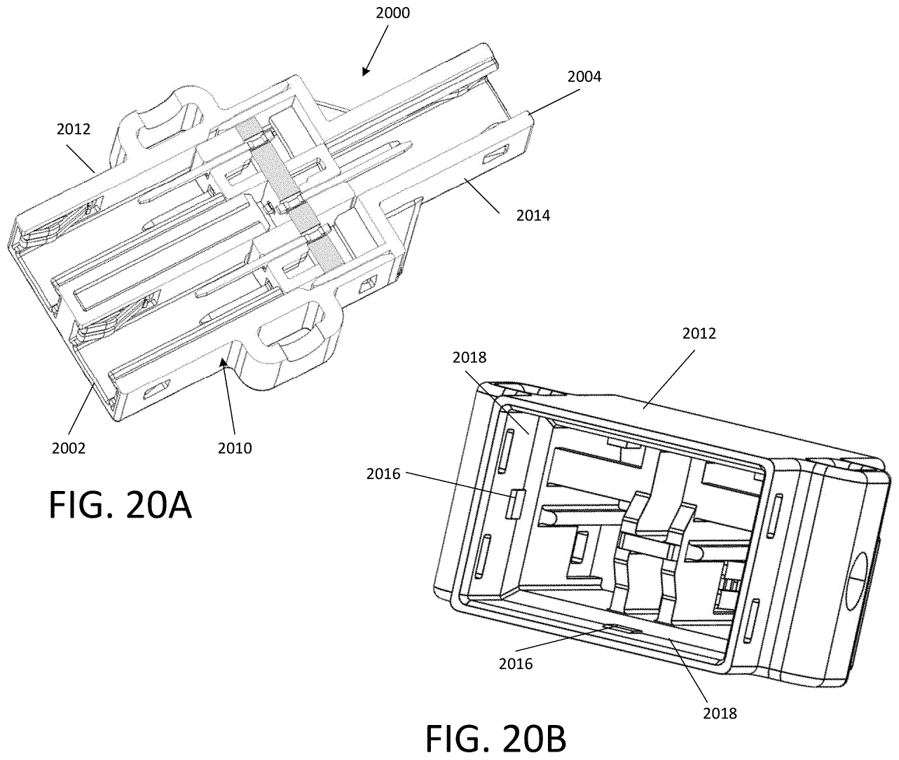

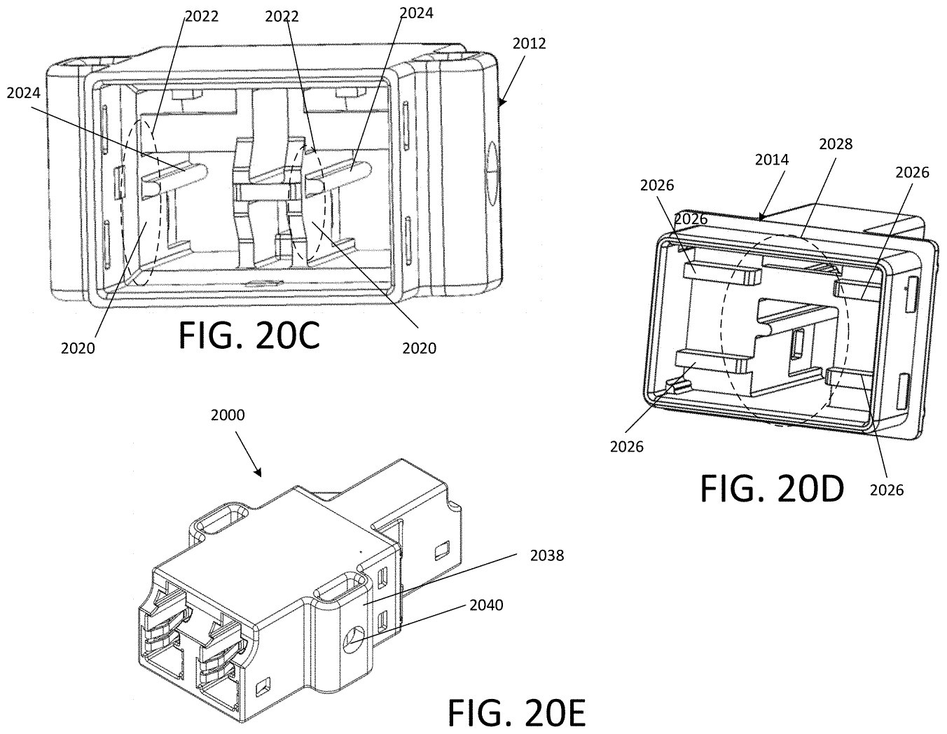

Referring to FIGS. 20A-20D various embodiments of a 3-way coupler with enhanced features are illustrated. Notably, the enhanced features are equally applicable to a 4-way coupler or a coupler for coupling only two connectors.

FIG. 20A provides a cross-sectional view of a 3-way coupler 2000 having a housing 2010 including a first body portion 2012 presenting a dual-connector end 2002 and a second body portion 2014 present a single-connector end 2004. In the illustrated embodiment. FIG. 20B, providing a rear perspective view of the first body portion 2012 of the 3-way coupler of FIG. 20A, illustrates the first body portion 2012 includes interference projections 2016, which are preferably provided on at least two inner sides, more preferably all four inner sides 2018 of the first body portion 2012 of the 3-way coupler 2000 as shown. The interference projections establish a shield bonding interference fit between the first body portion 2012 and the second body portion 2014 to ensure good contact between the body portions 2012, 2014.

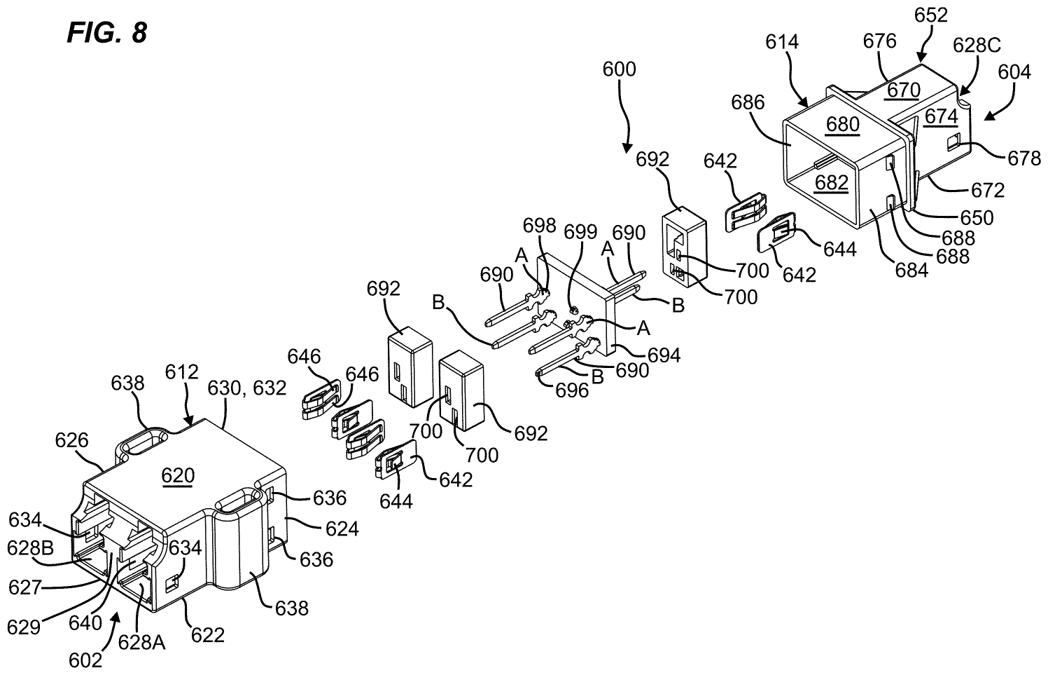

FIG. 20C, providing a rear perspective view of the first body portion 2012 of the 3-way coupler 2000, and FIG. 20D, providing a forward perspective view of the second body portion 2014 of the 3-way coupler, illustrate guide features that help to position and stabilize contact support blocks (e.g., contact support blocks 692 of FIG. 8). In FIG. 20C, the guide features of the first body portion 2012 include an extended wall 2020 establishing a recess 2022 with projection 2024 to receive an edge of a respective contact block. In FIG. 20D, the guide features of the second body portion 2014 include ribs 2026 that define a central recess 2028 to receive a respective contact block. In certain embodiments the contact blocks (e.g., contact support blocks 692 of FIG. 8) are provided with crush ribs for even further stabilization.

FIG. 20E provides a perspective view of the 3-way coupler 2000 illustrating an enhanced wire tie feature. As shown, the 3-way coupler 2000 includes a wire tie retainer opening 2038 (similar to the wire tire retainer opening 638 of FIG. 6) providing a top to bottom slot for a wire tie retainer but additionally includes a side access wire retainer opening 2040 (e.g., a circle-shaped opening). The side access wire tie retainer opening 2040 can be used in combination with a wire tie to secure the coupler 2000 to a support structure. Further, in some applications, to establish an electrical grounding path, the side access wire tie opening can receive a self-threading screw to which a grounding wire can be attached to create the desired grounding path.

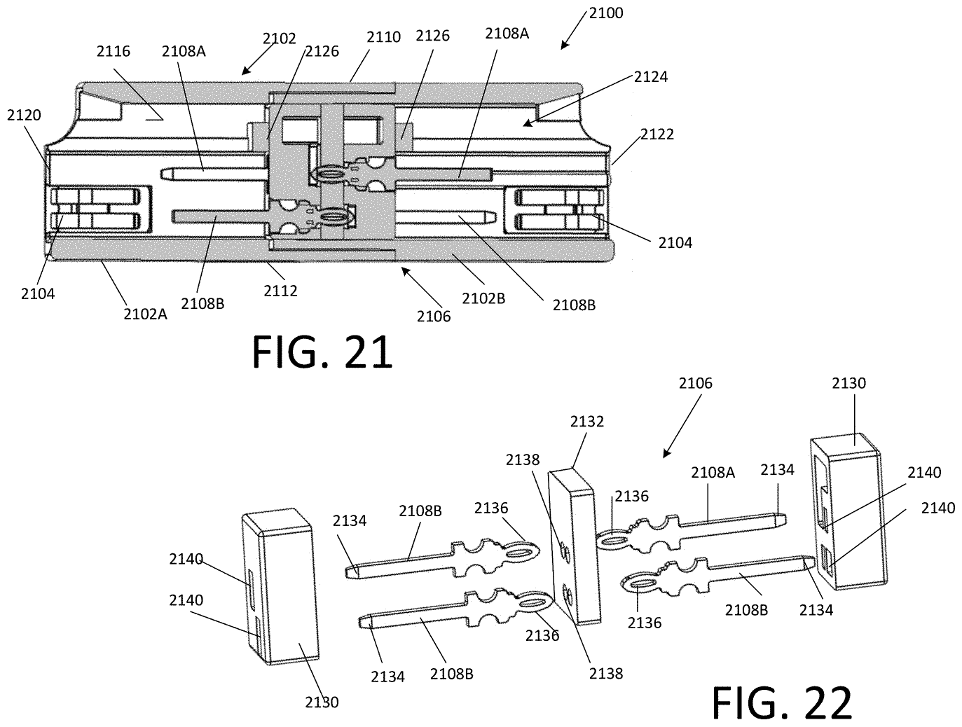

Referring now to FIGS. 21 and 22 embodiment of a coupler 2100 for coupling two free connector 200 is illustrated. As shown, the coupler 2100 generally corresponds to the coupler 400 described herein and includes a singular metal housing 2102, four bonding shield contacts 2104 (only two are shown) and a contact sub-assembly 2106.

The housing 2102, which is die cast in a symmetrical configuration, includes an upper face 2110 and a lower face 2112 connected by a first side face (not shown) and a second side face 2116 that, together, define identical first and second end faces 2120, 2122. The first and second faces 2120, 2122 surround a central cavity 2124 that extends the length of the coupler 2100 between first and second end face 2120, 2122. Each of the first and second end faces 2120, 2122 is configured to interface with and retain the cantilevered latch 230 of one of the connectors 200. Tabs 2126 are provided within the central cavity 2124 to assist in positioning and retaining the contact sub-assembly 2106. In certain embodiments, the housing 2102 is composed of two distinct sections 2102A and 2102B that mechanically interface to form a completed housing 2102; a two section housing provides a configuration in which the contact sub-assembly 2106 is more easily installed. In certain embodiments, the housing 2102 is of a unitary configuration. The housing 2102 can be of a shielded or unshielded configuration.

The contact sub-assembly 2106 includes two pairs of contacts 2108, with each pair of contacts including a first contact 2108A and a second contact 2108B, as well as two support blocks 2130 and a circuit board 2132. Each of the contacts 2108 includes a first end 2134 comprising a pin contact that is received within the tuning fork receptacle contacts 254a, 254b of the connector 200 and a second end 2136 into a corresponding via 2138 on the circuit board 2132. Each pair of contact 2108 is supported by a respective slot 2140 of the contact support block 2130 through which the contact 2108 extends. The contact support blocks 2130 are preferably of a lightweight non-conductive material such as plastic. A first set of traces on the circuit board 2132 electrically connects the first contacts 2108A of the two pairs of contacts 2108 while a second set of traces on the circuit board 2132 electrically the second contacts 2108B of the two pairs of contacts 2108.

It will be appreciated that aspects of the above embodiments may be combined in any way to provide numerous additional embodiments. These embodiments will not be described individually for the sake of brevity.

While the present invention has been described above primarily with reference to the accompanying drawings, it will be appreciated that the invention is not limited to the illustrated embodiments; rather, these embodiments are intended to disclose the invention to those skilled in this art. Note that features of one or more embodiments can be incorporated in other embodiments without departing from the spirit of the invention. In the drawings, like numbers refer to like elements throughout. Thicknesses and dimensions of some components may be exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

Herein, the terms “attached”, “connected”, “interconnected”, “contacting”, “mounted” and the like can mean either direct or indirect attachment or contact between elements, unless stated otherwise.

Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A multi-way coupler, comprising:
a housing having at least three connector-receiving channels;
a circuit board contained within housing; and
at least three pairs of contacts including exactly one pair of contacts per each of the at least three connector-receiving channels, each of the contacts including a forward end extending into the respective connector-receiving channel and a rearward end electrically coupled to the circuit board, each of the pair of contacts including a first contact and a second contact, wherein the circuit board includes a first set of traces electrically coupling all of the first contacts together and a second set of traces electrically coupling all of the second contacts together.

2. The multi-way coupler of claim 1, wherein the multi-way coupler comprises a three-way coupler.

3. The multi-way coupler of claim 1, where in the multi-way coupler comprises a four-way coupler.

4. The multi-way coupler of claim 1, wherein the housing comprises a shielded housing having a first body portion that interfaces with a second body portion.

5. The multi-way coupler of claim 1, further comprising a plurality of contact support blocks supporting the at least three pairs of contacts.

6. The multi-way coupler of claim 1, wherein each of the contacts of the at least three pairs of contacts include a pin contact.

7. The multi-way coupler of claim 1, wherein electrical coupling of the respective first and second contacts facilitates the transfer of both power and data between the at least three connector-receiving channels.

8. A configurable multi-way coupler, comprising:
a four-sided housing with each side of the housing configurable to present or not present a fixed connector;
a circuit board contained within the housing; and
at least two fixed connectors housed within the four-sided housing, each of the at least two fixed connectors configured to interface with a free connector, each of the at least two fixed connectors having exactly one pair of contacts comprising a first contact and a second contact, each of the first and second contacts having a rearward end that is electrically coupled to the circuit board and a forward end housed within the fixed connector, the circuit board including a first set of traces electrically coupling all of the first contacts together and a second set of traces electrically coupling all of the second contacts together.

9. The configurable multi-way coupler of claim 8, comprising at least three fixed connectors.

10. The configurable multi-way coupler of claim 8, comprising at least four connectors.

11. The configurable multi-way coupler of claim 8, wherein the electrical coupling of the respective first and second contacts facilitates the transfer of both power and data between the at least three connector-receiving channels.

12. A method for establishing a power and/or data system bus architecture, comprising:
supplying power and/or data via a first connector coupled to a first connector-receiving channel of a first coupler having at least three connector-receiving channels;
providing the supplied power and/or data via a second connector received in a second connector-receiving channel of the at least three connector-receiving channels of the first coupler to a first power device; and
providing the supplied power and/or data via a third connector received in a third connector-receiving channel of the at least three connector-receiving channels of the first coupler to a second coupler having at least three connector-receiving channels.

13. A method for establishing a power and/or data system bus architecture, comprising:
supplying power and/or data via a first connector coupled to a first connector-receiving channel of a first coupler having at least four connector-receiving channels;
providing the supplied power and/or data via a second connector received in a second connector-receiving channel of the at least four connector-receiving channels of the first coupler to a first power device;
providing the supplied power and/or data via a third connector received in a third connector-receiving channel of the at least four connector-receiving channels of the first coupler to a second power device; and
providing the supplied power and/or data via a fourth connector received in a fourth connector-receiving channel of the at least four connector-receiving channels of the first coupler to a second coupler having at least three connector-receiving channels.

14. The method of claim 11, wherein second coupler has at least four connector-receiving channels.

15. A coupler, comprising:
a housing having a first connector-receiving channel and a second connector-receiving channel;
a circuit board contained within housing; and
at least two pairs of contacts including exactly one pair of contacts per each of the first and second connector-receiving channels, each of the contacts including a forward end extending into the respective connector-receiving channel and a rearward end electrically coupled to the circuit board, each of the pair of contacts including a first contact and a second contact, wherein the circuit board includes a first set of traces electrically coupling all of the first contacts together and a second set of traces electrically coupling all of the second contacts together.

16. The coupler of claim 15, wherein electrical coupling of the respective first and second contacts facilitates the transfer of both power and data between the at least three connector-receiving channels.
